(19) United States
(12) Patent Application Publication
(10) Pub. No.: US 2024/0135440 A1
(43) Pub. Date: Apr. 25, 2024

(54) FINANCING OF RENTAL PROPERTIES

(71) Applicant: Wells Fargo Bank, N.A., San Francisco, CA (US)

(72) Inventors: Frank Fehrenbach, San Francisco, CA (US); Nathan Bray, San Francisco, CA (US)

(21) Appl. No.: 17/443,094

(22) Filed: Jul. 19, 2021

(51) Int. Cl. G06Q 40/02; G06Q 30/06; G06Q 50/16

(52) U.S. Cl. CPC G06Q 40/02; G06Q 30/0645; G06Q 50/16

(57) ABSTRACT

An example electronic computing device can include: a processor; and a system memory, the system memory including instructions which, when executed by the processor, cause the electronic computing device to: receive historical rental information for a rental property offered for rent by a rental service; analyze the historical rental information to generate a mortgage offer for a mortgage on the rental property; and upon acceptance of the mortgage offer, accept payment from the rental service to repay the mortgage on the rental property.

### BACKGROUND

The process of refinancing a rental property can be challenging. Satisfying the requirements for the refinance can be difficult. For instance, income from the rental property can be cyclical, thereby making it difficult to show a relevant income stream throughout the year and to commit to a repayment schedule that meets the needs of the rental property owner.

### SUMMARY

Embodiments of the disclosure are directed to the financing of rental properties.

In one aspect, an example electronic computing device includes: a processor; and a system memory, the system memory including instructions which, when executed by the processor, cause the electronic computing device to: receive historical rental information for a rental property offered for rent by a rental service; analyze the historical rental information to generate a mortgage offer for a mortgage on the rental property; and upon acceptance of the mortgage offer, accept payment from the rental service to repay the mortgage on the rental property.

The details of one or more techniques are set forth in the accompanying drawings and the description below. Other features, objects, and advantages of these techniques will be apparent from the description, drawings, and claims.

### DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 shows an example system for facilitating the refinancing of rental properties.

FIG. 2 shows example logical components of a financial institution computing device of the system of FIG. 1.

FIG. 3 shows an example method for facilitating refinancing of rental properties.

FIG. 4 shows example components of the financial institution computing device of FIG. 1.

### DETAILED DESCRIPTION

Various embodiments will be described in detail with reference to the drawings, wherein like reference numerals represent like parts and assemblies through the several views. Reference to various embodiments does not limit the scope of the claims attached hereto. Additionally, any examples set forth in this specification are not intended to be limiting and merely set forth the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

The examples provided herein are directed to the financing of rental properties.

In the examples provided herein, a property owner owns a rental property, such as a house, apartment, etc. The rental property owner uses a rental service to assist in renting the rental property. The rental service facilitates the renting of a rental property for a property owner. In some examples, the rental service is an online marketplace for rental properties, such as Airbnb, Inc. and Vrbo. The rental service allows a property owner to list a property for rent, and the rental service facilitate the rental process between the rental property owner and the renter. This can include the rental agreement and payment for the rental.

The rental service has the historical rental information associated with the property, such as how often the property is rented, the rent charged, etc. The historical rental information can be obtained for a certain amount of time, such as 6 months, one year, two years, five years, etc. This historical rental information from the rental service is used by a financial institution to facilitate the financing of a mortgage on the property. For instance, the financial institution can use the historical rental information to identify a finance amount, define a repayment schedule, and/or obtain payment directly from the rental service.

The examples provided herein are discussed with respect to the refinancing of an existing mortgage on the rental property. However, aspects of this disclosure can also be applied without requiring the refinancing of an existing mortgage. For example, aspects of this disclosure can be applied to the financing of a rental property that does not have an existing mortgage, such as an offer for a first mortgage or home equity line of credit.

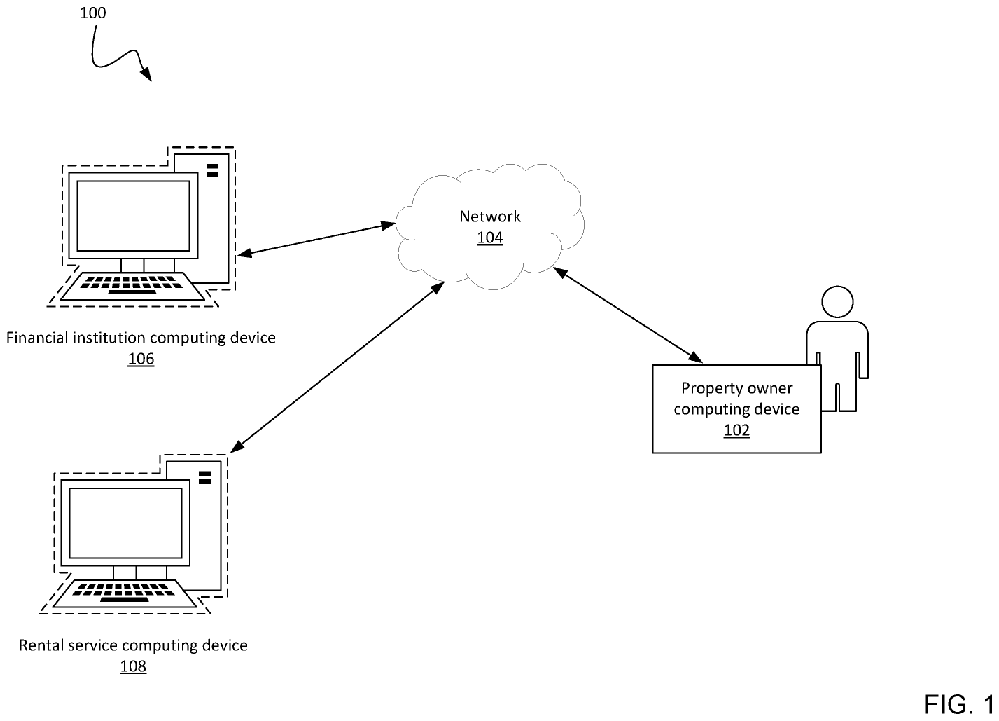

FIG. 1 illustrates an example system 100 that facilitates the refinancing of rental properties. The system 100 includes a rental property owner computing device 102, a network 104, a financial institution computing device 106, and a rental service computing device 108. More or fewer computing devices can be provided in the example system 100.

In this example, the rental property owner computing device 102 is associated with an owner of a rental property. The financial institution computing device 106 is associated with the financial institution, such as a bank. As described more below, the rental property owner computing device 102 can communicate through the network 104 with the financial institution computing device 106 and the rental service computing device 108. Although the financial institution computing device 106 and the rental service computing device 108 are depicted as single devices, in a typical environment the financial institution computing device 106 and the rental service computing device 108 could be servers in server farms and/or cloud computing environments.

In this example, the rental property owner computing device 102 communicates with the financial institution computing device 106 in order to facilitate an existing mortgage on the property and refinancing of that mortgage. The rental property owner computing device 102 also communicates with the rental service computing device 108 to list the property for rental and facilitate the renting of the rental property. Finally, the financial institution computing device 106 communicates with the rental property owner computing device 102 and the rental service computing device 108 to facilitate the financing of the rental property.

The example network 104 is a computer network and can be any type of wireless network, wired network, and cellular network, including the Internet. As noted, the rental property owner computing device 102, the financial institution computing device 106, and the rental service computing device 108 can communicate with each other via the network 104.

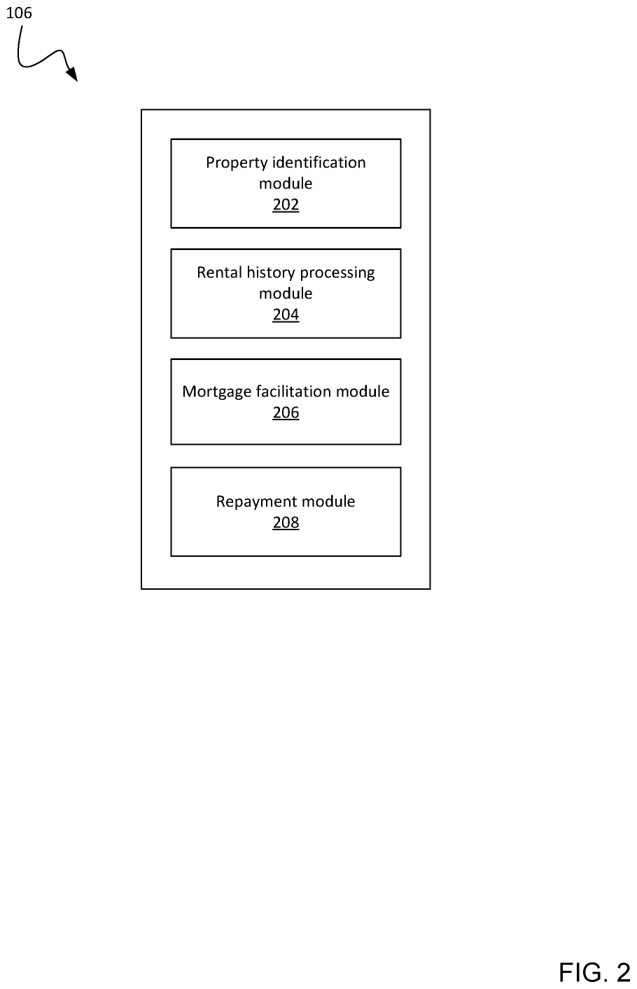

FIG. 2 illustrates example logical components of the financial institution computing device 106. In this example, the financial institution computing device 106 includes a property identification module 202, a rental history processing module 204, a mortgage facilitation module 206, and a repayment module 208. Additional or different modules or functionality can also be provided.

The property identification module 202 is programmed to identify a rental property for refinancing. In one example, the rental property has an existing mortgage with the financial institution, and the property identification module 202 identifies the rental property as a candidate for refinancing using the functionality below.

In another example, the rental property owner initiates a request for refinancing. For instance, the rental property owner can make a request directly with the financial institution computing device 106 for refinancing, which is received by the property identification module 202.

In another example, the rental property owner can select an advertisement for refinancing to initiate the refinancing of the rental property. For instance, the property identification module 202 can identify the rental property as being a candidate for refinancing, and an advertisement can be provided to the rental property owner within the user interface(s) served by the rental service computing device 108 to the rental property owner computing device 102. The rental property owner can then select other otherwise respond to the advertisement to initiate the refinancing with the property identification module 202. In other embodiments, the financial institution can directly message (e.g., through email, text message, etc.) the rental property owner to offer the refinance. Other configurations are possible.

The rental history processing module 204 is programmed to obtain rental information about the rental property upon initiation of the refinancing. In one example, the rental history processing module 204 is configured to communicate with the rental service computing device 108 to obtain historical rental information like the rental amount obtained for the rental property, the number of days rented, etc.

In one example, the rental history processing module 204 communicates with the rental service computing device 108 through an Application Programming Interface (API) provided by the rental service computing device 108. In this example, the rental history processing module 204 provides an identifier for the rental property through the API, and the API returns the historical rental information to the rental history processing module 204. In other embodiments, the request for the historical rental information can be made through other mechanisms, both automated and manual. The rental property owner can authorize the release of the historical rental information to the financial institution.

The rental history processing module 204 is further programmed to process the rental history information to determine the possible terms for the refinancing. For example, the rental history processing module 204 can use rental income information from the historical rental information to determine a proper refinance amount, term, and/or interest rate.

The mortgage facilitation module 206 is programmed to facilitate the refinancing process, should the rental property owner decide to proceed with the refinancing of the mortgage associated with the rental property.

For instance, the mortgage facilitation module 206 can be programmed to make an offer to the rental property owner for refinancing based upon the refinancing terms identified by the rental history processing module 204. In this example, the terms can include the refinance amount, term, and interest rate.

Should the rental property owner decide to proceed with the refinancing, the mortgage facilitation module 206 can provide a fully or partially-automated underwriting process for the refinancing. For instance, the financial institution can use information already known about the rental property owner along with information from third parties, such as the rental service and/or other third parties like Zillow. An example of a system that minimizes necessary input from the property owner is described in U.S. patent application Ser. No. 16/225,636 filed on Dec. 19, 2018.

The repayment module 208 is programmed to facilitate repayment of the refinanced amount by the rental property owner. There are various repayment terms that are offered by the repayment module 208.

In one instance, the repayment module 208 offers standard repayment options for the refinanced amount, such as a set payment that is made each month to the financial institution computing device 106.

In another example, the repayment module 208 offers to accept payment directly from the rental service computing device 108 based upon rental income that is made from the rental property. For example, the rental income that is normally provided to the rental property owner by the rental service for the rental of the rental property can be directly provided to the financial institution computing device 106 to pay the refinanced amount.

This can be a set amount each month (such as the monthly payment amount or other set amount) that is taken by the financial institution directly from the rental service computing device 108 until the monthly payment amount is paid in full. Thereupon, further rental income is paid to the rental property owner. In other examples, a certain percentage of each rental amount is paid by the rental service computing device 108 directly to the financial institution. The rental property owner pays any amount not covered by the rental amounts each month.

In some examples, one or more incentives can be offered by the financial institution for automatic payments directly from the rental services. For example, a reduction in certain terms (e.g., interest rate, escrow requirements, insurance requirements, etc.) can be provided to encourage the autopayments from the rental service.

In some embodiments, the financial institution can credit the amount to the monthly payment for the refinanced amount before the actual rental occurs. For instance, many rental services do not provide income from the rental amount to the rental property owner until the renters actually complete or at least initiate the stay at the rental property, which can be days, weeks, or months in the future. In these instances, the financial institution can provide a credit amount toward the monthly payment for the refinanced amount in advance of the actual payment from the rental service computing device 108 to the financial institution computing device 106.

In yet other embodiments, the repayment module 208 can be programmed to change the monthly payment amounts based upon the historical rental information received from the rental service computing device 108.

For example, the renting of some rental properties is seasonal or cyclical in nature. In such instances, the repayment module 208 can increase the monthly payment in months in which the rental income has been more and decrease, delay, and/or eliminate the monthly payment in months in which the rental income has been less.

For example, for a vacation home located in the south, there may be more rental income in the winter and less rental income in the summer. In such a scenario, the repayment module 208 is programmed to increase the monthly payment in the winter and decrease or eliminate the monthly payment in the summer. Many other configurations are possible.

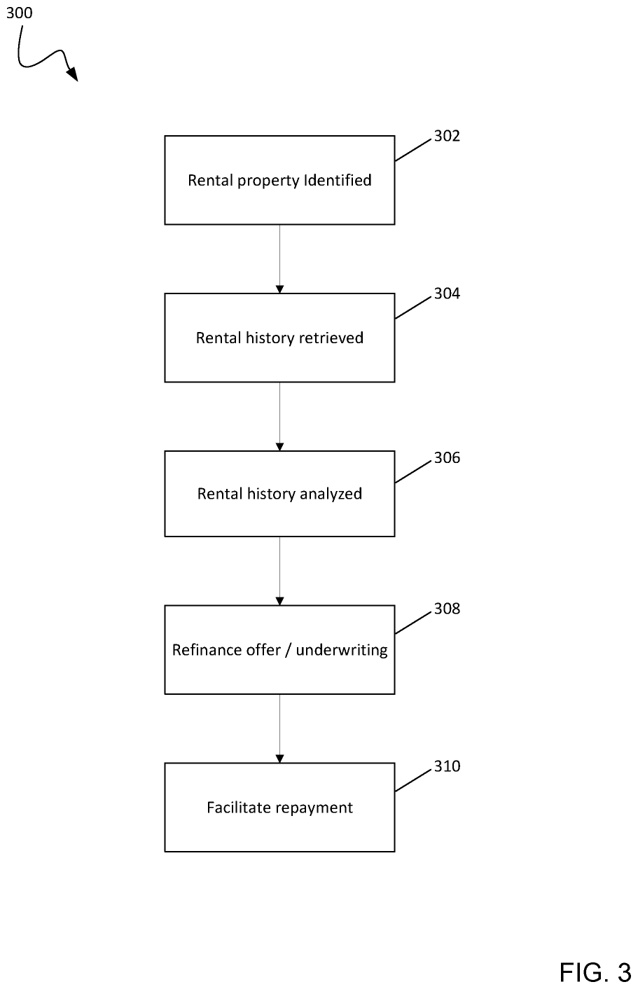

Referring now to FIG. 3, an example method 300 for refinancing a rental property is shown. In this example, the method 300 is performed by the system 100 described above.

At operation 302, the rental property is identified. As discussed, this can be done in various ways, such as by the rental property owner requesting the refinance and/or the financial institution contacting the rental property owner (e.g., through advertisement or direct messaging) to offer the refinance.

Next, at operation 304, the historical rental information is retrieved. As noted, this can be done automatically through a request to the rental service. The historical rental information can include the rental amount, number of days rented, etc.

Next, at operation 306, the historical rental information is analyzed to determine the proper terms for the refinance offer. As noted, these terms can include the mortgage amount, interest rate, and/or repayment terms.

Next, at operation 308, the refinance offer is delivered to the rental property owner. Upon acceptance, the underwriting process for the offer is completed in a fully-automated or semi-automated fashion.

Finally, at operation 310, the repayment of the refinanced mortgage is facilitated. This can include receiving at least a portion of the monthly payment directly from the rental service out of the rental income from the rental property, as described herein.

The examples provided herein result in a more efficient system that facilitates mortgages and refinancing. For example, the processing of the historical rental information results in the practical application of a more efficient system for making refinancing offers. Further, the automated repayment directly from the rental service to the financial institution reduces electronic exchanges between the parties, thereby further streamlining the processing necessary to effectuate payment for the refinanced mortgage.

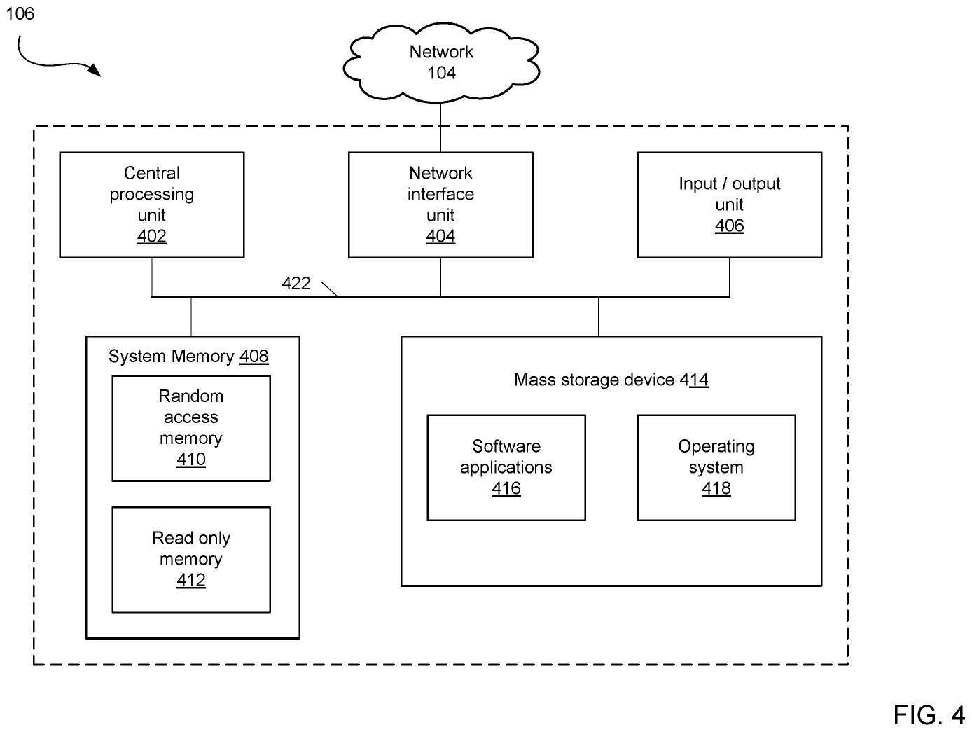

As illustrated in FIG. 4, the example financial institution computing device 106 includes at least one central processing unit (“CPU”) 402, also referred to as a processor, a system memory 408, and a system bus 422 that couples the system memory 408 to the CPU 402. The system memory 408 includes a random access memory (“RAM”) 410 and a read-only memory (“ROM”) 412. A basic input/output system that contains the basic routines that help to transfer information between elements within the financial institution computing device 106, such as during startup, is stored in the ROM 412. The financial institution computing device 106 further includes a mass storage device 414. The mass storage device 414 is able to store software instructions and data. Some or all of the components of the financial institution computing device 106 can also be included in the computing devices 102, 108 and any other computing devices described herein.

The mass storage device 414 is connected to the CPU 402 through a mass storage controller (not shown) connected to the system bus 422. The mass storage device 414 and its associated computer-readable data storage media provide non-volatile, non-transitory storage for the financial institution computing device 106. Although the description of computer-readable data storage media contained herein refers to a mass storage device, such as a hard disk or solid state disk, it should be appreciated by those skilled in the art that computer-readable data storage media can be any available non-transitory, physical device or article of manufacture.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the financial institution computing device 106.

According to various embodiments of the invention, the financial institution computing device 106 may operate in a networked environment using logical connections to remote network devices through the network 104, such as a wireless network, the Internet, or another type of network. The financial institution computing device 106 may connect to the network 420 through a network interface unit 404 connected to the system bus 422. It should be appreciated that the network interface unit 404 may also be utilized to connect to other types of networks and remote computing systems. The financial institution computing device 106 also includes an input/output controller 406 for receiving and processing input from a number of other devices, including a touch user interface display screen, or another type of input device. Similarly, the input/output controller 406 may provide output to a touch user interface display screen or other type of output device.

As mentioned briefly above, the mass storage device 414 and the RAM 410 of the financial institution computing device 106 can store software instructions and data. The software instructions include an operating system 418 suitable for controlling the operation of the financial institution computing device 106. The mass storage device 414 and/or the RAM 410 also store software instructions and software applications 416, that when executed by the CPU 402, cause the financial institution computing device 106 to provide the functionality of the financial institution computing device 106 discussed in this document. For example, the mass storage device 414 and/or the RAM 410 can store software instructions that, when executed by the CPU 402, cause financial institution computing device 106 to display data on the display screen of the financial institution computing device 106.

Although various embodiments are described herein, those of ordinary skill in the art will understand that many modifications may be made thereto within the scope of the present disclosure. Accordingly, it is not intended that the scope of the disclosure in any way be limited by the examples provided.

1. An electronic computing device, comprising:
a processor; and
a system memory, the system memory including instructions which, when executed by the processor, cause the electronic computing device to:
request, through an application programming interface associated with the rental service, historical rental information that is specific for a single rental property offered for rent by a rental service, wherein the request includes an identifier for the rental property, and wherein the historical rental information includes rental income information and a number of days rented for the rental property;
receive, through the application programming interface, the historical rental information for the rental property offered for rent by the rental service that is associated with the identifier;
analyze the historical rental information to generate a mortgage offer for a mortgage on the rental property;
upon acceptance of the mortgage offer:
communicate a payment amount of the mortgage on the rental property to the rental service; and
accept direct payment from the rental service to repay the monthly payment of the mortgage on the rental property; and
increase a monthly payment for months when rental income for the rental property increases based upon the historical rental information including the rental income information and the number of days rented for the rental property.

2. The electronic computing device of claim 1, wherein the mortgage is a refinance of an existing mortgage on the rental property.

3. The electronic computing device of claim 1, further comprising instructions which, when executed by the processor, cause the electronic computing device to request the historical rental information from the rental service.

4-5. (canceled)

6. The electronic computing device of claim 1, further comprising instructions which, when executed by the processor, cause the electronic computing device to provide an incentive for the payment in advance of the rental service transferring the payment.

7. The electronic computing device of claim 1, further comprising instructions which, when executed by the processor, cause the electronic computing device to lower a payment amount upon acceptance of the payment from the rental service.

8. An electronic computing device, comprising:
a processor; and
a system memory, the system memory including instructions which, when executed by the processor, cause the electronic computing device to:
request, through an application programming interface associated with the rental service, historical rental information that is specific for a single rental property offered for rent by a rental service, wherein the request includes an identifier for the rental property, and wherein the historical rental information includes rental income information and a number of days rented for the rental property;
receive, through the application programming interface, the historical rental information from the rental service, for the rental property offered for rent by the rental service that is associated with the identifier;
analyze the historical rental information to generate a mortgage offer to a rental property owner for a mortgage on the rental property;
upon acceptance of the mortgage offer:
communicate a payment amount of the mortgage on the rental property to the rental service; and
accept direct payment from the rental service to repay the monthly payment of the mortgage on the rental property; and
increase a monthly payment for months when rental income for the rental property increases based upon the historical rental information including the rental income information and the number of days rented for the rental property.

9. The electronic computing device of claim 8, wherein the mortgage is a refinance of an existing mortgage on the rental property.

10-11. (canceled)

12. The electronic computing device of claim 8, further comprising instructions which, when executed by the processor, cause the electronic computing device to provide an incentive for the payment in advance of the rental service transferring the payment.

13. The electronic computing device of claim 8, further comprising instructions which, when executed by the processor, cause the electronic computing device to lower a payment amount upon acceptance of the payment from the rental service.

14. A method for refinancing a mortgage on a rental property, the method comprising:
requesting, through an application programming interface associated with the rental service, historical rental information that is specific for a single rental property offered for rent by a rental service, wherein the request includes an identifier for the rental property, and wherein the historical rental information includes rental income information and a number of days rented for the rental property;
receiving, through the application programming interface, the historical rental information for the rental property offered for rent by the rental service that is associated with the identifier;
analyzing the historical rental information to generate a refinancing offer for the mortgage on the rental property;
upon acceptance of the refinancing offer:
communicating a payment amount of the mortgage on the rental property to the rental service; and
accepting direct payment from the rental service to repay the monthly payment of the mortgage on the rental property; and
increasing a monthly payment for months when rental income for the rental property increases based upon the historical rental information including the rental income information and the number of days rented for the rental property.

15. The method of claim 14, further comprising requesting the historical rental information from the rental service.

16-17. (canceled)

18. The method of claim 14, further comprising providing an incentive for the payment in advance of the rental service transferring the payment.

19. The method of claim 14, further comprising lowering a payment amount upon acceptance of the payment from the rental service.

20. (canceled)
